(19) United States
(12) Patent Application Publication
(10) Pub. No.: US 2012/0144916 A1
(43) Pub. Date: Jun. 14, 2012

(54) SINGLE GYROSCOPE-BASED APPROACH TO DETERMINING SPATIAL GAIT PARAMETERS

(76) Inventors: Emer Doheny, Dublin (IE); Barry R. Greene, Dublin (IE)

(21) Appl. No.: 12/963,356

(22) Filed: Dec. 8, 2010

(51) Int. Cl. G01C 19/02

(52) U.S. Cl. 73/504.08

(57) ABSTRACT

Methods and systems may include a single gyroscope and gait logic to receive angular velocity data from the single gyroscope. The gait logic can also determine a stride length of an individual based on the angular velocity data. In one example, the gait logic integrates the angular velocity data to obtain angular displacement data and determines a stride length based at least in part on the angular displacement data.

### BACKGROUND

1. Technical Field

Embodiments generally relate to gait analysis. More particularly, embodiments relate to the use of a single gyroscope-based approach to determining spatial gait parameters.

2. Discussion

Falls in the elderly may represent a substantial healthcare problem worldwide. Indeed, a significant percentage of people over seventy years of age experience a significant fall, and the frequency of falls increases with age and the level of frailty. Gait analysis can be a useful tool in predicting falls risk. Conventional approaches to conducting gait analysis may involve mounting multiple gyroscopes to each leg of the subject. For example, one gyroscope could be attached to a thigh of the subject and a second gyroscope could be attached to a shank (e.g., shin) of the subject, wherein the data from the gyroscopes might be used to determine the stride length and other gait parameters of the subject. Other techniques for conducting gait analysis may involve the use of a gyroscope in conjunction with an accelerometer. While the above approaches may be suitable under certain circumstances, there still remains considerable room for improvement. For example, the accelerometer-based approach may be highly sensitive with regard to accelerometer placement on the subject, and both approaches can involve complex calculations and relatively high cost.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a block diagram of an example of a model for conducting gait analysis based on data from a single gyroscope according to an embodiment;

FIG. 2 is a perspective view of an example of an individual with a single gyroscope mounted to a shank of each leg according to an embodiment;

FIG. 3 is a flowchart of an example of a method of conducting a gait analysis according to an embodiment; and

FIG. 4 is a block diagram of an example of a system according to an embodiment.

### DETAILED DESCRIPTION

Embodiments may provide for a system including a single gyroscope and gait logic to receive angular velocity data from the single gyroscope. The gait logic can also determine a stride length of an individual based on the angular velocity data from the single gyroscope.

Embodiments can also include a computer readable storage medium having a set of stored instructions which, if executed by a processor, cause a computer to receive angular velocity data from a single gyroscope and determine a stride length of an individual based on the angular velocity data from the single gyroscope.

Other embodiments may provide for a method in which stride data is received from a single gyroscope mounted to a shank of an individual, wherein the stride data includes angular velocity data for the shank of the individual. The method can also involve identifying a plurality of strides based on the stride data and integrating the angular velocity data to obtain angular displacement data for the shank of the individual. A stride length may be determined for each of the plurality of strides based on the angular displacement data, a height of the individual, a scaling factor and a trigonometric cosine rule.

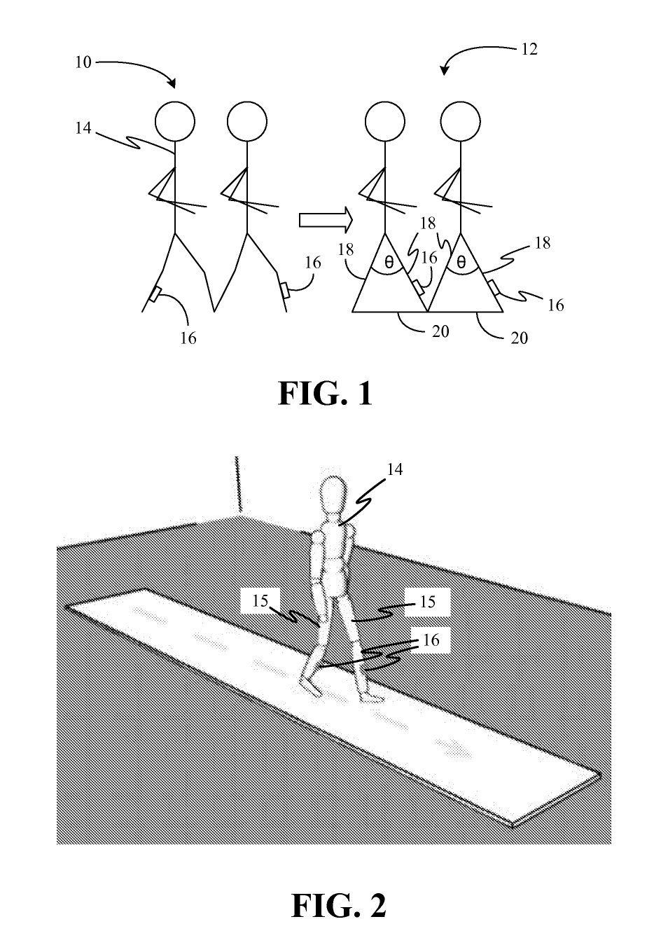

FIG. 1 shows a scenario 10 in which an individual 14 walks with a single gyroscope 16 mounted to a shank (e.g., lower left or right leg) of the individual, and a model 12 of the movement of the individual 14, wherein the model 12 can be used to determine spatial gait parameters for the individual 14 based solely on data from the single gyroscope 16. In particular, the thigh and shank of the leg of the individual 14 are approximated as a single segment in the illustrated model 12 so that the structural gait of the individual 14 may be treated as an isosceles triangle having two sides 18 of equal length and a third side 20 opposite an angle θ of the triangle. The length of the third side 20 can be considered the stride length (L_{stride}), wherein the trigonometric cosine rule may be given as,

L_{stride}=\sqrt{2a²(1−cos θ)} (1)

Where “a” is the length of the sides 18 of the isosceles triangle. Substituting a scaled factor of height, S×H, for the sides 18 and simplifying equation (1) can provide the expression,

L_{stride}=S×H\sqrt{2(1−cos θ)} (2)

Thus, by determining a scaling factor “S”, a height (e.g., estimated or measured) of the individual “H” and the angle θ, which can be considered an angular displacement value, the stride length may be determined.

The angular displacement can be derived from the stride data received from the single gyroscope 16. In particular, the stride data from the single gyroscope 16 can include angular velocity data, which may be integrated in the sagittal plane (e.g., imaginary vertical plane dividing the individual into left and right portions) to obtain angular displacement data. Additionally, the integration can be reset for each stride in order to reduce the likelihood of integration drift in the angular displacement calculation.

The scaling factor “S” may be determined by conducting an optimization process versus a control spatial gait analysis system such as the GAITRite system from CIR Systems, Inc., of Havertown, Pa., USA (“baseline system”), wherein the scaling factor can be selected to minimize the error between the illustrated model 12 and the baseline system. In one example, a scaling factor of 0.3318 provided an acceptable level of error between the experimental system and the baseline system, although other scaling factors might be used depending upon the circumstances (e.g., population, age, gender, physical surroundings). As will be discussed in greater detail, other gait parameters such as distance traveled and gait velocity may also be determined based on the stride length.

FIG. 2 shows the individual 10 in a setting in which a gyroscope 16 is mounted to each shank. While the stride length can be determined from only a single gyroscope 16, the illustrated approach of one gyroscope 16 per leg can be used to provide additional data where appropriate. Moreover, the simplified calculation model 12 (FIG. 1) enables stride length determinations to be made without mounting a gyroscope to the thighs 15 of the individual 10 and without the need for an accelerometer to accompany the gyroscope 16.

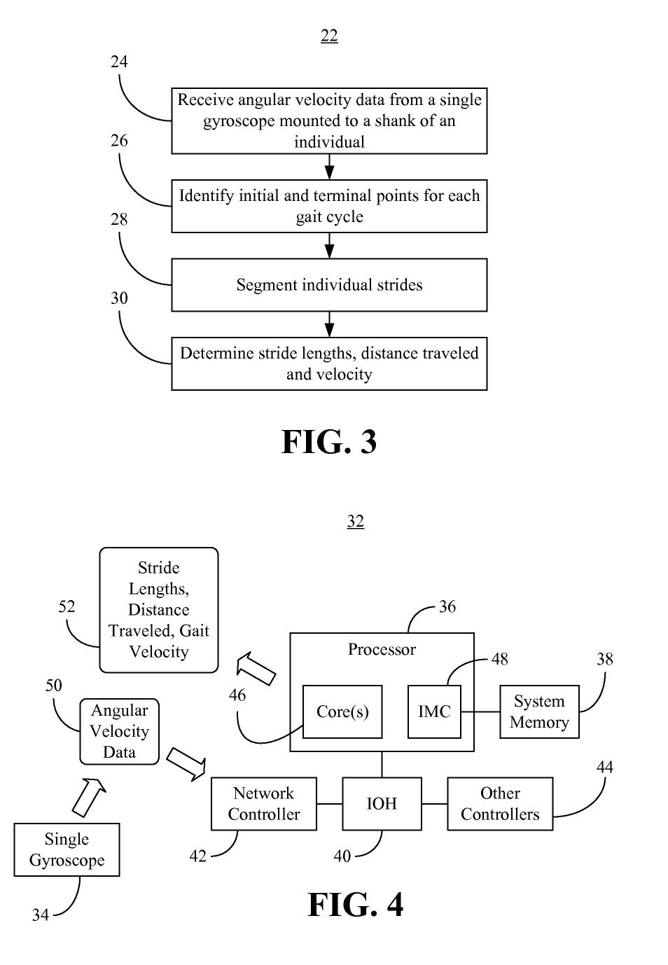

Turning now to FIG. 3, a method 22 of conducting a gait analysis is shown. The method 22 may be implemented in executable software as a set of logic instructions stored in a machine- or computer-readable medium of a memory such as random access memory (RAM), read only memory (ROM), programmable ROM (PROM), firmware, flash memory, etc., in fixed-functionality hardware logic using circuit technology such as application specific integrated circuit (ASIC), complementary metal oxide semiconductor (CMOS) or transistor-transistor logic (TTL) technology, or any combination thereof. For example, computer program code to carry out operations shown in method 22 may be written in any combination of one or more programming languages, including an object oriented programming language such as Java, Smalltalk, C++ or the like and conventional procedural programming languages, such as the “C” programming language or similar programming languages.

Processing block 24 provides for receiving angular velocity data from a single gyroscope mounted to a shank of an individual. For example, the individual might be walking in a home or healthcare setting in which a more detailed understanding of the individual's falls risk is desired. Initial (e.g., heel strike) and terminal (e.g., toe off) contact points for each gait cycle may be identified from the angular velocity data at block 26. Approaches to determining the heel strike and toe off points might include identifying local maxima and/or minima in the angular velocity. In addition, illustrated block 28 provides for segmenting individual strides in the walk based on the angular velocity data, wherein a stride can be defined as the time between successive heel strikes.

A stride length may be determined for each of the plurality of strides at block 30 based on the angular velocity data. As already noted, stride length determinations can be made by integrating angular velocity data from the stride data to obtain angular displacement data, and calculating the stride lengths based on angular displacement data, a height (e.g., estimated or measured) of the individual, a scaling factor and the trigonometric cosine rule. Block 30 might also involve conducting an integration reset for each of the plurality of strides (e.g., after every heel strike) in order to reduce integration drift. Illustrated block 30 also provides for determining distance traveled. One approach to such a determination might involve summing the plurality of stride lengths, as indicated in the following expression.

Dist_traveled=ΣL_{stride} (3)

Additionally, gait velocity can be determined at block 30 based on the distance traveled and the identified heel strikes, as indicated in the following expression.

$$Velocity = \frac{Dist\_traveled}{( {T}_{HSlast} - {T}_{HSfirst} )} \qquad ( 4 )$$

Where T_{HSlast} represents the time of the last detected heel strike and T_{HSfirst} represents the time of the first detected heel strike.

FIG. 4 shows a computing system 32 having a single gyroscope 34, a processor 36, system memory 38, an input/output hub (IOH) 40, a network controller 42, and various other controllers 44. The system 32 could be part of a mobile platform such as a laptop, personal digital assistant (PDA), mobile Internet device (MID), wireless smart phone, media player, imaging device, etc., or any combination thereof. For example, the system 32 might be implemented in a wireless smart phone carried by an individual performing a TUG (timed up and go) test in a primary care, community care or home setting. In addition, the system 32 may also be part of a fixed platform such as a personal computer (PC), server, workstation, etc. Thus, the processor 36 may include one or more processor cores 46 capable of executing a set of stored logic instructions, and an integrated memory controller (IMC) 48 configured to communicate with the system memory 38. The system memory 38 could include dynamic random access memory (DRAM) configured as a memory module such as a dual inline memory module (DIMM), a small outline DIMM (SODIMM), etc.

The illustrated IOH 40, sometimes referred to as a Southbridge of a chipset, functions as a host device and communicates with the network controller 42, which could provide off-platform communication functionality for a wide variety of purposes such as cellular telephone (e.g., W-CDMA (UMTS), CDMA2000 (IS-856/IS-2000), etc.), WiFi (e.g., IEEE 802.11, 1999 Edition, LAN/MAN Wireless LANS), Low-Rate Wireless PAN (e.g., IEEE 802.15.4-2006, LR-WPAN), Bluetooth (e.g., IEEE 802.15.1-2005, Wireless Personal Area Networks), WiMax (e.g., IEEE 802.16-2004, LAN/MAN Broadband Wireless LANS), Global Positioning System (GPS), spread spectrum (e.g., 900 MHz), and other radio frequency (RF) telephony purposes. In the illustrated example, the network controller 42 obtains angular velocity data 50 wirelessly (e.g., from a data aggregator over a Bluetooth connection), and provides the angular velocity data 50 to the processor 36 for further analysis. The processor 36 may execute gait logic that receives the angular velocity data 50 from the single gyroscope 34, and outputs gait parameters 52 such as stride lengths, distance traveled and gait velocity, based on the angular velocity data.

The single gyroscope 34 might be a calibrated one-dimensional (1D), two-dimensional (2D) or three-dimensional (3D) gyroscope capable of generating angular velocity data about the medio lateral axis (e.g., in the sagittal plane) when coupled to the shank of an individual. In addition, the other controllers 44 could communicate with the IOH 40 to provide support for user interface devices such as a display, keypad, mouse, etc. in order to allow a user to interact with and perceive information from the system 32. The gait parameters 52 could be output via the other controllers 44, the network controller 42, and so on.

Thus, the use of fewer gyroscopes to determine stride length can be more cost efficient and easier to implement, enabling the system 32 to be implemented by a wider population. Moreover, a single gyroscope-based approach can reduce processing power and extend battery life. The system 32 can be used to identify frailty in the elderly and predict falls, to monitor exercise activity and to perform a host of other gait related functions.

Embodiments of the present invention are applicable for use with all types of semiconductor integrated circuit (“IC”) chips. Examples of these IC chips include but are not limited to processors, controllers, chipset components, programmable logic arrays (PLA), memory chips, network chips, and the like. In addition, in some of the drawings, signal conductor lines are represented with lines. Some may be thicker, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments of the present invention are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments of the invention. Further, arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments of the invention, it should be apparent to one skilled in the art that embodiments of the invention can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. might be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A method comprising:
receiving angular velocity data from a single gyroscope mounted to a shank of an individual;
identifying a plurality of strides based on the angular velocity data;
integrating the angular velocity data to obtain angular displacement data for the shank of the individual;
determining a stride length for each of the plurality of strides based on the angular displacement data, a height of the individual, a scaling factor and a trigonometric cosine rule.

2. The method of claim 1, further including conducting an integration reset for each of the plurality of strides.

3. The method of claim 1, further including summing each of the stride lengths to determine a distance traveled.

4. The method of claim 3, further including:
identifying a plurality of heel strikes based on the angular velocity data; and
determining a gait velocity based on the distance traveled and the plurality of heel strikes.

5. A computer readable storage medium comprising a set of stored instructions which, if executed by a processor, cause a computer to:
receive angular velocity data from a single gyroscope; and
determine a stride length of an individual based on the angular velocity data.

6. The medium of claim 5, wherein the instructions, if executed, cause a computer to:
integrate the angular velocity data to obtain angular displacement data for the shank of the individual; and
determine the stride length based on the angular displacement data.

7. The medium of claim 6, wherein the stride length is to be determined further based on a height of the individual, a scaling factor and a trigonometric cosine rule.

8. The medium of claim 6, wherein the instructions, if executed, further cause a computer to:
identify a plurality of strides based on the angular velocity data; and
determine a stride length for each of the plurality of strides to obtain a plurality of stride lengths.

9. The medium of claim 8, wherein the instructions, if executed, further cause a computer to conduct an integration reset for each of the plurality of strides.

10. The medium of claim 8, wherein the instructions, if executed, further cause a computer to sum the plurality of stride lengths to determine a distance traveled.

11. The medium of claim 10, wherein the instructions, if executed, further cause a computer to:
identify a plurality of heel strikes based on the angular velocity data; and
determine a gait velocity based on the distance traveled and the plurality of heel strikes.

12. The medium of claim 5, wherein the single gyroscope is to be mounted to a shank of the individual.

13. A system comprising:
a single gyroscope; and
gait logic to,
receive angular velocity data from the single gyroscope, and
determine a stride length of an individual based on the angular velocity data.

14. The system of claim 13, wherein the gait logic is to,
integrate the angular velocity data to obtain angular displacement data for the shank of the individual, and
determine the stride length based on the angular displacement data.

15. The system of claim 14, wherein the stride length is to be determined further based on a height of the individual, a scaling factor and a trigonometric cosine rule.

16. The system of claim 14, wherein the gait logic is to,
identify a plurality of strides based on the angular velocity data, and
determine a stride length for each of the plurality of strides to obtain a plurality of stride lengths.

17. The system of claim 16, wherein the gait logic is to further conduct an integration reset for each of the plurality of strides.

18. The system of claim 16, wherein the gait logic is to sum the plurality of stride lengths to determine a distance traveled.

19. The system of claim 18, wherein the gait logic is to,
identify a plurality of heel strikes based on the angular velocity data, and
determine a gait velocity based on the distance traveled and the plurality of heel strikes.

20. The system of claim 13, wherein the single gyroscope is to be mounted to a shank of the individual.
